(19) United States
(12) Patent Application Publication
(10) Pub. No.: US 2020/0009811 A1
(43) Pub. Date: Jan. 9, 2020

(54) METHODS OF FORMING CONTACT LENSES TO CONTAIN BIOACTIVE AGENTS

(71) Applicant: ClearVision Sciences, Inc., Hayward, CA (US)

(72) Inventors: Tahua Yang, Woodridge, IL (US); Charlie Chen, San Ramon, CA (US)

(21) Appl. No.: 16/429,174

(22) Filed: Jun. 3, 2019

Related U.S. Application Data
(60) Provisional application No. 62/693,874, filed on Jul. 3, 2018.

(51) Int. Cl. B29D 11/00; G02C 7/04

(52) U.S. Cl. CPC B29D 11/00096; G02C 7/049; G02B 1/043; B29D 11/00134; B29D 11/00865

(57) ABSTRACT

A method of forming and/or using a contact lens is disclosed. In one step, bioactive agents are pad printed to form a layer. In another step, the layer is cured to form a portion of the contact lens. The contact lens is shipped to users in dry state without immersing in aqueous packaging solution.

### RELATED APPLICATION DATA

The instant application claims priority to U.S. provisional application Ser. No. 62/693,874, filed Jul. 3, 2018 the subject matter of which is incorporated by reference herein in its entirety.

### FIELD OF THE DISCLOSURE

This disclosure relates to methods of forming contact lens to contain bioactive agents.

### BACKGROUND

Using eye drops is a common method to treat eye conditions. This method is convenient but inefficient because it delivers short, uncontrollable treatments due to the fast turnover rate of tears. The compliance issue of using eye drops to treat ophthalmic conditions is typically poor. Patients often forget about the treatment regimen when their conditions do not involve discomfort or pain.

A reliable method is needed to controllably deliver bioactive agents into eyes.

### SUMMARY

In one embodiment, a method of forming and/or using a contact lens is disclosed. One step comprises pad printing bioactive agents to form a layer. Another step comprises curing the layer to form a portion of the contact lens.

In another embodiment, a method of forming and/or using a contact lens is disclosed. One step comprises soaking a pre-manufactured contact lens in a solution of bioactive agents so that the pre-manufactured contact lens uploads the bioactive agents into the pre-manufactured contact lens to form the contact lens. Another step comprises, after the soaking step, drying the contact lens and shipping the contact lens in a dry state. Still another step comprises, after the shipping step, disposing the contact lens in a first shape in a liquid buffer solution for less than five minutes. Yet another step comprises, after the disposing step, the contact lens changing into a second intended shape without distortion after being in the liquid buffer solution for less than five minutes.

In still another embodiment, a method of forming and/or using a contact lens is disclosed. One step comprises filling a mold with a monomer mix comprising bioactive agents. Another step comprises, after the filling step, closing the mold. Yet another step comprises, after the closing step, curing the monomer mix. Still another step comprises, after the curing step, opening the mold. Yet another step comprises, after the opening step, removing the contact lens, formed by the cured monomer mix, from the mold.

The scope of the present disclosure is defined solely by the appended claims and is not affected by the statements within this summary.

### BRIEF DESCRIPTION OF THE DRAWINGS

The disclosure can be better understood with reference to the following drawings and description. The components in the figures are not necessarily to scale, emphasis instead being placed upon illustrating the principles of the disclosure.

FIG. 1 is a flowchart illustrating one embodiment of a method of forming and/or using a contact lens;

FIG. 2 is a table illustrating one embodiment of materials and their respective weights that can be used for the composition of pre-polymers to assist in forming a contact lens;

FIG. 3 is a table illustrating one embodiment of resins which may be used to assist in forming a contact lens;

FIGS. 4-6 are tables illustrating varying embodiments of materials and their respective weight percentages that can be used for the composition of monomer mixes used to assist in forming a contact lens;

FIG. 7 is a flowchart of another embodiment of a method of forming and/or using a contact lens;

FIG. 8 is a flowchart of another embodiment of a method of forming and/or using a contact lens;

FIG. 9 illustrates a box diagram of one embodiment of a system which may be used to manufacture contact lenses using the methods disclosed herein;

FIG. 10 illustrates a top view of one embodiment of a contact lens formed using the system and/or methods disclosed herein; and

FIG. 11 illustrates a cross-section view through line 11-11 of the contact lens of FIG. 10.

### DETAILED DESCRIPTION

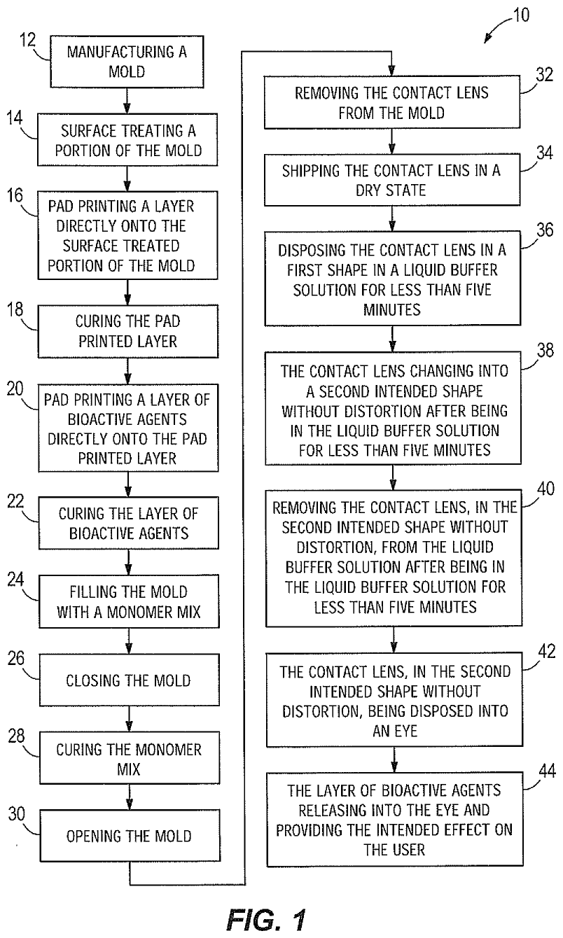

FIG. 1 is a flowchart illustrating one embodiment of a method 10 of forming and/or using a contact lens. The method 10 is used to form a dry contact lens which is defined as a contact lens which is kept in a dry-state during shipment after manufacturing as opposed to contact lens which are shipped in a solution. In other embodiments, the method 10 may be used to form varying types of contact lens.

Step 12 comprises manufacturing a mold. In one embodiment, the mold may be manufactured using injection molding to form male and female mating portions of the mold. The mold may be made from a variety of materials such as homo-polymers or copolymers including Polypropylene, Ethylene vinyl alcohol, Polybutylene Terephthalate, Polystyrene, and Nylon. The mold may be dimensionally stable within two hours after manufacture for shrinkage consistency. Nucleating agents may be used to speed up the molding process. In other embodiments, the mold may be manufactured using varying materials, systems, and methods.

Step 14 comprises surface treating a portion of the mold. The surface treatment is used so that in later steps the contact lens will stay on the surface treated portion of the mold when the mold is opened (demolded). In one embodiment, a male mating portion of the mold is surface treated while the female mating portion of the mold is not surface treated. In another embodiment, a female mating portion of the mold is surface treated while the male mating portion of the mold is not surface treated. The surface treatment may comprise plasma (air or oxygen), corona, flame, chemical, or wet chemistry with a contact angle less than 60 degrees. In other embodiments, the surface treatment may vary.

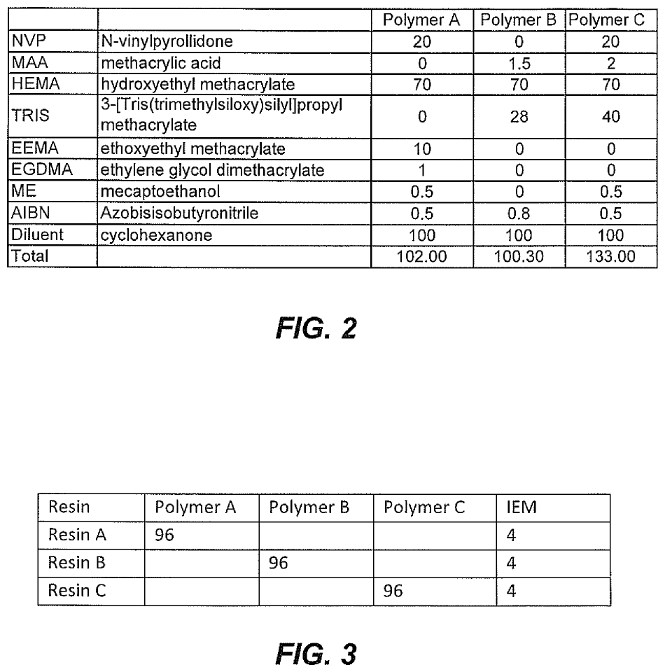

Step 16 comprises pad printing a layer directly onto the surface treated portion of the mold. FIG. 2 is a table illustrating one embodiment of the materials and their respective weights that can be used for the composition of pre-polymers used in forming the pad printed layer. The monomers and diluent (less than thirty grams total) of the table shown in FIG. 2 are added into a 100 milliliter flask. A stir bar is then added, the combination purged with Nitrogen for ten minutes, and the flask capped. While being magnetically stirred in the first 3 hours, the flask is heated to 50 degrees Celsius for 18 hours. The solution then becomes viscous and is heated to 100 degrees Celsius for one hour.

To form the ultraviolet curable resins used to form the pad printed layer, 30 grams of prepolymer and 1.2 grams (4% weight) of Isocyanato Ethyl Methacrylate are added into a 100 milliliter glass bottle. 0.1% of Dibutyltin Dilaurate is added as a catalyst. The combination is mixed well using a stirrer. The bottle is capped and kept at room temperature for 24 hours. Subsequently, the Isocyanate group reacts. FIG. 3 is a table illustrating the resultant resins which are then refrigerated for further use.

Prior to use, the resin of the table of FIG. 3 is added to 1% of Irgacure 819 and to diluent Cyclohexanone to adjust the viscosity for the pad printing process. The solution is then mixed well. The ultraviolet curable resins are used for a clear coat layer. Based on the clear coat formulation, an active agent or additive is added. The solution is then mixed. The resultant ultraviolet curable formulation is used for the active ingredient layer. The active agent or additive can include: (1) a blue light blocker, including BL01 (4-Phenyldiazenyl)phenyl-2-methacrylate, CAS#3774-20-7, or insoluble Leuco dye particles like Vat Yellow 3(CAS # 82-18-8); (2) a Photochromic agent such as the compounds used in transition glass lenses; and/or (3) a pharmaceutical active agent used for dry eye relief or glaucoma treatment. A solvent may be added to the formulation to enhance miscibility in case solubility is needed.

A clear coat solution (without additives or bioactive agents) is made by adding 30 grams of prepolymer and 1.2 grams (4% weight) of Isocyanato Ethyl Methacrylate into a 100 ml glass bottle. 0.1% of Dibutyltin Dilaurate is added as a catalyst. The solution is mixed well. The glass bottle is then capped at kept at room temperature for 24 hours. Subsequently, the Isocyanate group reacts. The resins, listed in the table of FIG. 3, are then kept in a refrigerator for further use.

The active ingredient, as described above, is added to a clear coat formulation and mixed well by stirring. The layer is then pad printed onto the surface treated portion of the mold. First, a layer of clear coat resin is printed on top of the surface treated portion of the mold. After air drying for thirty minutes, or curing with 365 nanometer ultraviolet irradiation for five seconds to two minute (depending on ultraviolet intensity), the active ingredient layer is printed on top of the clear coat. As discussed below in step 18, the coated mold is then cured under 365 nanometer ultraviolet irradiation for five seconds to two minute (depending on ultraviolet intensity) to fully cure the resin layers. After curing, the resin layers are no longer sticky and insoluble in Cyclohexanone.

In one embodiment, the pad printed layer may comprise ionic resins to accommodate the absorption of bioactive agents (discussed later herein) with ionic nature. The ionic resins can be anionic or cationic based on the desired bioactive agents used. In another embodiment, the pad printed layer may be non-ionic to minimize potential proteins absorption and accumulation on the surface of the contact lens.

The thickness of the pad printed layer may be less than 20 micrometers, and preferably less than 10 micrometers. The viscosity of the pad printed layer may be between 500 and 30,000 centipoise, and preferably between 1,000 and 10,000 centipoise, and most preferably between 1,000 and 5,000 centipoise. In other embodiments, the pad printed layer may be formed and applied using varying materials in varying percentages, and the viscosity and thickness of the pad printed layer may vary.

Step 18 comprises curing the pad printed layer. The pad printed layer may be ultraviolet cured, radiation cured, or cured by heat. The pad printed layer may be cured at a wavelength of 320-365 nanometers. The pad printed layer may be completely or partially cured. In other embodiments, the pad printed layer may be cured utilizing varying systems and methods using varying parameters.

Step 20 comprises pad printing a layer of bioactive agents directly onto the pad printed layer. This step may take place during manufacture of the contact lens. The bioactive agents comprise agents that have an effect on a living organism such as a tissue or cell. The bioactive agents may include pharmaceutical active ingredients such as medicines for anti-allergy, anti-microbial, anti-fungal, anti-inflammatory, steroids, sodium channel blockers, carotenoids, myopia suppressive agents, hyaluronic acid, collagens, dry eye, amniotic compositions and glaucoma treatments, and non-pharmaceutical agents such as water-soluble lubricant polymers, and less water-soluble phospholipids. The layer of bioactive agents is pad printed outside of a center portion, comprising an intended line of vision, of the contacts lens to avoid interfering with vision when used. The thickness of the layer of bioactive agents may be less than 20 micrometers, and preferably less than 10 micrometers. The composition of the pad printed layer of bioactive agents may be adjusted in order to incorporate different bioactive agents of various ratios of hydrophilicity/hydrophobicity. The advantage of this is that it allows for independently formulating the composition of the pad printed layer of bioactive agents without significantly affecting the chemistry of the entire contact lens, as opposed to blending the bioactive agents into the contact lens. Changing the ratio of hydrophilic and hydrophobic monomers in the resin of the pad printed layer, the hydrophilicity/hydrophobicity ratio can be predictably controlled. In other embodiments, the layer of bioactive agents may vary in type, material, and size and may be deposited onto the pad printed layer using varying manufacturing systems and methods.

Step 22 comprises curing the layer of bioactive agents. The layer of bioactive agents may be ultraviolet cured, radiation cured, or cured by heat. The layer of bioactive agents may be cured at a wavelength of 365 nanometers and UV intensity of 2 mW/cm², for 120 seconds, at 30 watts. The layer of bioactive agents may be completely or partially cured. In other embodiments, the layer of bioactive agents may be cured utilizing varying systems and methods using varying parameters.

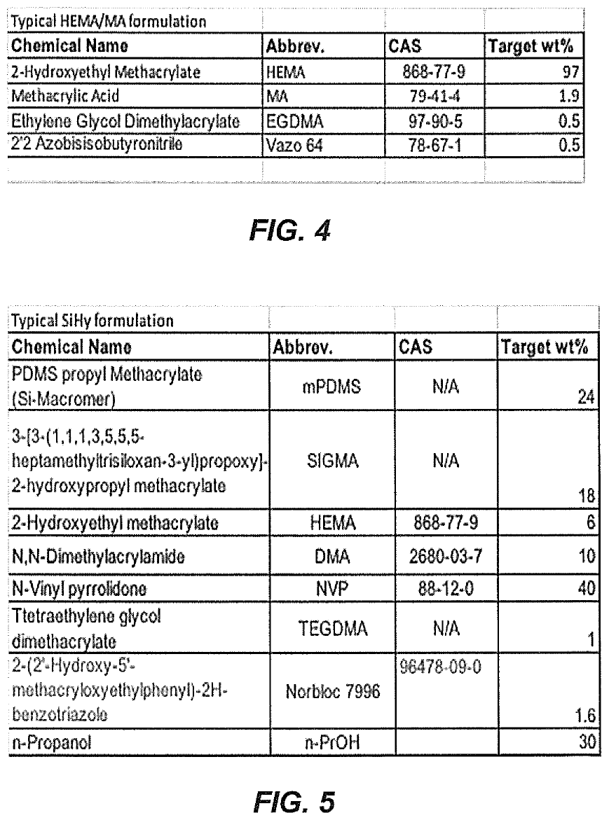

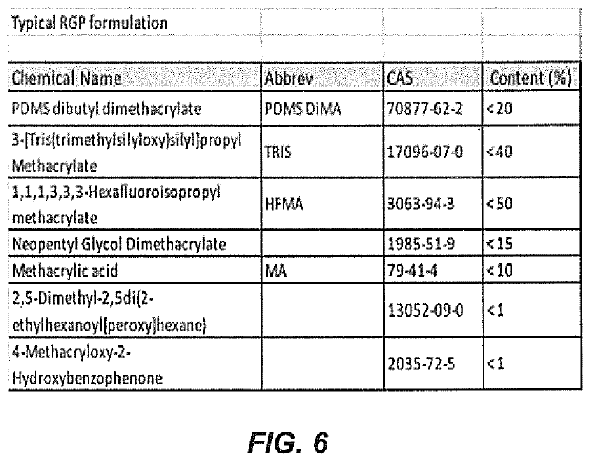

Step 24 comprises filling the mold with a monomer mix. In one embodiment, the female mating portion of the mold which is surface treated and which contains the cured pad printed layer is filled with a monomer mix. In another embodiment in which the male mating portion of the mold is surface treated and contains the cured pad printed layer, the female mating portion of the mold is filled with a monomer mix. FIGS. 4, 5, and 6 each provide a table illustrating varying embodiments of the materials and their respective weight percentages that can be used for the composition of the monomer mix. The volume of the fill may be in a range of 20 microliters to 100 microliters without bubbles. In other embodiments, the monomer mix may vary in type, composition, materials and material percentages, and volume.

Step 26 comprises closing the mold. The mold may be closed manually or automatically. In one embodiment, closing the mold comprises mating the male and female portions of the mold. The mold is closed in good alignment with no bubbles. In other embodiments, the mold may be closed in other manners using varying systems and methods.

Step 28 comprises curing the monomer mix. The monomer mix may be ultraviolet cured, radiation cured, or cured by heat. The monomer mix may be cured at 70 degrees Fahrenheit, at an intensity of 1-4 mW/cm², at a wavelength of 365 nanometers, for 5 minutes to one hour, at 30 watts. In other embodiments, the monomer mix may be cured utilizing varying systems and methods using varying parameters.

Step 30 comprises opening the mold. In one embodiment, the mating male and female portions of the mold are de-mated during this step. When the mold is opened and the mating male and female portions of the mold are de-mated, the contact lens, which comprises the cured contents of the mold formed by the cured pad printed layer, the cured bioactive agents layer, and the cured monomer mix, stays on the surface treated portion of the mold due to more adhesion between the surface treated portion of the mold and the contact lens than the other portion of the mold. In other embodiments, the mold may be opened using varying systems and methods.

Step 32 comprises removing the contact lens from the mold. The contact lens is removed at a room temperature of around 70 degrees Fahrenheit. There may be a float-off of water or water/IPA (water/Isopropyl Alcohol) of in the range of 0% to 70% of IPA. The contact lens may be removed using a robot or other automated system. The removed contact lens may then be washed in alcohol or an aqueous medium, followed by drying and packaged in dry condition. The contact lens has the layer of bioactive agents disposed within an interior of the contact lens between exterior layers. In other embodiments, the contact lens may be removed from the mold using varying parameters, systems, and methods.

Step 34 comprises shipping the contact lens in a dry state. In this dry state the contact lens is not in a solution and is dry. In other embodiments, the contact lens may be shipped in varying states.

Step 36 comprises disposing the contact lens in a first shape in a liquid buffer solution for less than five minutes. When the contact lens is disposed in the liquid buffer solution, the bioactive agents start to release. In other embodiments, the contact lens may be disposed in varying shapes in the liquid buffer solution for a varying amount of time.

Step 38 comprises the contact lens changing into a second intended shape without distortion after being in the liquid buffer solution for less than five minutes. The dry contact lens swells to take its second intended shape which is its equilibrium shape in its original round and non-distorted shape. The shorter the time it takes to change into this second intended shape, the faster the contact lens hydration is. The second intended shape without distortion is the shape the contact lens is intended by the manufactured to be in when disposed into an eye. The liquid buffer solution comprises 0.09% of sodium chloride, 20 mM of sodium monohydrogen phosphate and sodium dihydrogen phosphate in distilled water. In other embodiments, commercially available multi-purpose solutions or artificial tears are also suitable to be used instead of liquid buffer solutions. In other embodiments, the contact lens may change into varying shapes without distortion after being in the liquid buffer solution for varying amounts of time.

Step 40 comprises removing the contact lens, in the second intended shape without distortion, from the liquid buffer solution after being in the liquid buffer solution for less than five minutes. In other embodiments, the contact lens is removed in varying intended shapes from the liquid buffer solution after varying amounts of time.

Step 42 comprises the contact lens, in the second intended shape without distortion, being disposed into an eye. The contact lens may be disposed into a human or animal's eye to improve vision. The layer of bioactive agents does not interfere with the user's vision since the layer of bioactive agents is disposed outside of the center portion, comprising the optical zone, of the contact lens. In other embodiments, the contact lens is disposed in varying intended shapes into an eye.

Step 44 comprises the layer of bioactive agents releasing bioactive agents into the eye and providing the intended effect on the user. The layer of bioactive agents may controllably, gradually, uniformly, steadily, and consistently release bioactive agents into the eye. In one embodiment, the layer of bioactive agents may steadily release bioactive agents into the eye over a course of 1, 7, 14, or 30 days, depending on the desired applications. The bioactive agents may improve or keep steady a condition of the user such as a medical condition. In other embodiments, the layer of bioactive agents may release bioactive agents into the eye in varying amounts over varying time ranges and may have varying effects on the user.

In other embodiments, one or more steps of the method 10 may be varied in substance or order, one or more steps of the method 10 may not be followed, or one or more additional steps may be added to the method 10.

For instance, in one embodiment of the method 10, steps 16 and 18 are not followed to eliminate the pad printed layer of steps 16 and 18, and step 20 comprises pad printing the layer of bioactive agents directly onto the surface treated portion of the mold. The contact lens then comprises the cured contents of the mold formed by the cured bioactive agents layer and the cured monomer mix.

In another embodiment of the method 10, steps 12, 14, 16, 18, 24, 26, 28, 30, and 32 are not followed, step 20 comprises pad printing the bioactive agents to form a layer on a pre-manufactured contact lens, and step 22 comprises curing the layer of pad printed bioactive agents on the pre-manufactured contact lens to form the portion of the contact lens. The pre-manufactured contact lens can be pre-manufactured using a cast molding process, a spin casting process, a lathing process, or using another type of system or method to pre-manufacture the contact lens.

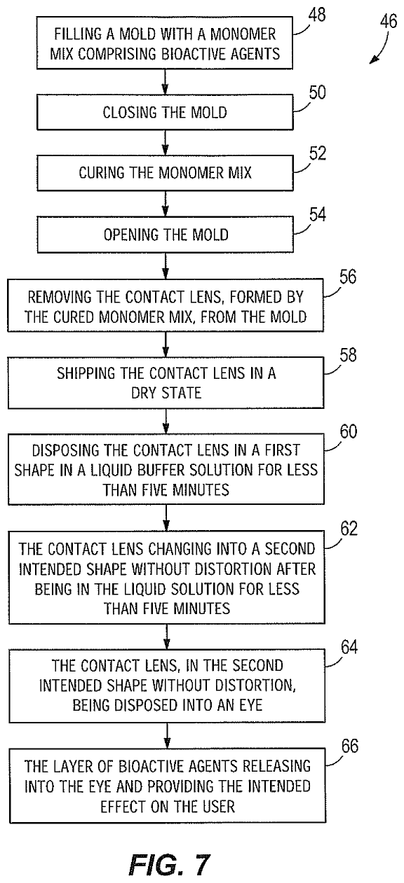

FIG. 7 is a flowchart of another embodiment of a method 46 of forming and/or using a contact lens. The method 46 may be used to form a rigid gas permeable dry contact lens. In other embodiments, the method may be used to form varying types of contact lenses. Step 48 comprises filling a mold with a monomer mix comprising bioactive agents. The bioactive agents comprise agents that have an effect on a living organism such as a tissue or cell. The bioactive agents may include pharmaceutical active ingredients such as medicines for anti-allergy, anti-microbial, anti-fungal, anti-inflammatory, steroids, sodium channel blockers, carotenoids, myopia suppressive agents, hyaluronic acid, collagens, dry eye, amniotic compositions and glaucoma treatments, and non-pharmaceutical agents such as water-soluble lubricant polymers, and less water-soluble phospholipids. In other embodiments, the bioactive agents may vary in type, material, and size and may be added to the mold using varying manufacturing systems and methods.

Step 50 comprises closing the mold. In one embodiment, closing the mold comprises mating the male and female portions of the mold. The mold is closed in good alignment with no bubbles. In other embodiments, the mold may be closed in other manners using varying systems and methods.

Step 52 comprises curing the monomer mix. The monomer mix may be ultraviolet cured, radiation cured, or cured by heat. The monomer mix may be cured at 70 degrees Fahrenheit, at an UV intensity of 1-4 mW/cm², at a wavelength of 365 nanometers, for a range in between of 5 to 60 minutes. In other embodiments, the monomer mix may be cured utilizing varying systems and methods using varying parameters.

Step 54 comprises opening the mold. In one embodiment, the mating male and female portions of the mold are de-mated during this step. When the mold is opened and the mating male and female portions of the mold are de-mated. The contact lens comprises the cured monomer mix with bioactive agents. In other embodiments, the mold may be opened using varying systems and methods.

Step 56 comprises removing the contact lens, formed by the cured monomer mix with bioactive agents, from the mold. The contact lens is removed at a room temperature of around 70 degrees Fahrenheit. There may be a float-off of water or water/IPA (water/Isopropyl Alcohol) of in the range of 0% to 70% of IPA. The contact lens may be removed using a robot or other automated system. In other embodiments, the contact lens may be removed from the mold using varying parameters, systems, and methods.

Step 58 comprises shipping the contact lens in a dry state. In this dry state the contact lens is not in a solution and is dry. In other embodiments, the contact lens may be shipped in varying states.

Step 60 comprises disposing the contact lens in a first shape in a liquid buffer solution for less than five minutes. When the contact lens is disposed in the liquid buffer solution, the bioactive agents start to release. In other embodiments, the contact lens may be disposed in varying shapes in the liquid buffer solution for a varying amount of time.

Step 62 comprises the contact lens changing into a second intended shape without distortion after being in the liquid solution for less than five minutes. The dry contact lens swells to take its second intended shape which is its equilibrium shape in its original round and non-distorted shape. The shorter the time it takes to change into this second intended shape, the faster the contact lens hydration is. The second intended shape without distortion is the shape the contact lens is intended by the manufactured to be in when disposed into an eye. The liquid buffer solution comprises 0.09% of sodium chloride, 20 mM of sodium monohydrogen phosphate and sodium dihydrogen phosphate in distilled water. In other embodiments, commercially available multi-purpose solutions or artificial tears are also suitable to be used instead of liquid buffer solutions. In other embodiments, the contact lens may change into varying shapes without distortion after being in the liquid buffer solution for varying amounts of time.

Step 64 comprises the contact lens, in the second intended shape without distortion, being disposed into an eye. The contact lens may be disposed into a human or animal's eye to improve vision. In other embodiments, the contact lens is disposed in varying intended shapes into an eye.

Step 66 comprises the bioactive agents releasing into the eye and providing the intended effect on the user. The bioactive agents may controllably, gradually, uniformly, steadily, and consistently release into the eye. In one embodiment, the bioactive agents may steadily release into the eye over a course of 1, 7, 14, or 30 days, depending on the desired applications. The bioactive agents may improve or keep steady a condition of the user such as a medical condition. In other embodiments, the bioactive agents may release into the eye in varying amounts over varying time ranges and may have varying effects on the user.

In other embodiments, one or more steps of the method 46 may be varied in substance or order, one or more steps of the method 46 may not be followed, or one or more additional steps may be added to the method 46.

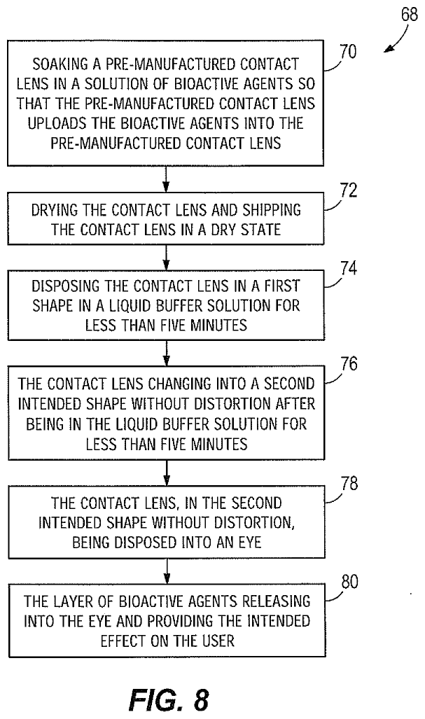

FIG. 8 is a flowchart of another embodiment of a method 68 of forming and/or using a contact lens. Step 70 comprises soaking a pre-manufactured contact lens in a solution of bioactive agents so that the pre-manufactured contact lens uploads the bioactive agents into the pre-manufactured contact lens. The bioactive agents comprise agents that have an effect on a living organism such as a tissue or cell. The bioactive agents may include pharmaceutical active ingredients such as medicines for anti-allergy, anti-microbial, anti-fungal, anti-inflammatory, steroids, sodium channel blockers, carotenoids, myopia suppressive agents, hyaluronic acid, collagens, dry eye, amniotic compositions and glaucoma treatments, and non-pharmaceutical agents such as water-soluble lubricant polymers, and less water-soluble phospholipids. In other embodiments, the bioactive agents may vary in type, material, and size and may be added to the contact lens using varying manufacturing systems and methods. The pre-manufactured contact lens may comprise a rigid gas permeable dry contact lens. The pre-manufactured contact lens may be pre-manufactured by molding, lathe cutting, casting, or by other methods. In other embodiments, the pre-manufactured contact lens may vary in type.

Step 72 comprises drying the contact lens and shipping the contact lens in a dry state. The contact lens may be dried using varying systems and methods. In this dry state the contact lens is not in a solution and is dry. In other embodiments, the contact lens may be shipped in varying states.

Step 74 comprises disposing the contact lens in a first shape in a liquid buffer solution for less than five minutes. When the contact lens is disposed in the liquid buffer solution, the bioactive agents start to release. In other embodiments, the contact lens may be disposed in varying shapes in the liquid buffer solution for a varying amount of time.

Step 76 comprises the contact lens changing into a second intended shape without distortion after being in the liquid buffer solution for less than five minutes. The dry contact lens swells to take its second intended shape which is its equilibrium shape in its original round and non-distorted shape. The shorter the time it takes to change into this second intended shape, the faster the contact lens hydration is. The second intended shape without distortion is the shape the contact lens is intended by the manufactured to be in when disposed into an eye. The liquid buffer solution comprises 0.09% of sodium chloride, 20 mM of sodium monohydrogen phosphate and sodium dihydrogen phosphate in distilled water. In other embodiments, commercially available multi-purpose solutions or artificial tears are also suitable to be used instead of liquid buffer solutions. In other embodiments, the contact lens may change into varying shapes without distortion after being in the liquid buffer solution for varying amounts of time.

Step 78 comprises the contact lens, in the second intended shape without distortion, being disposed into an eye. The contact lens may be disposed into a human or animal's eye to improve vision. In other embodiments, the contact lens is disposed in varying intended shapes into an eye.

Step 80 comprises the bioactive agents releasing into the eye and providing the intended effect on the user. The bioactive agents may controllably, gradually, uniformly, steadily, and consistently release into the eye. In one embodiment, the bioactive agents may steadily release into the eye over a course of 1, 7, 14, or 30 days, depending on the desired applications. The bioactive agents may improve or keep steady a condition of the user such as a medical condition. In other embodiments, the bioactive agents may release into the eye in varying amounts over varying time ranges and may have varying effects on the user.

In other embodiments, one or more steps of the method 68 may be varied in substance or order, one or more steps of the method 68 may not be followed, or one or more additional steps may be added to the method 68.

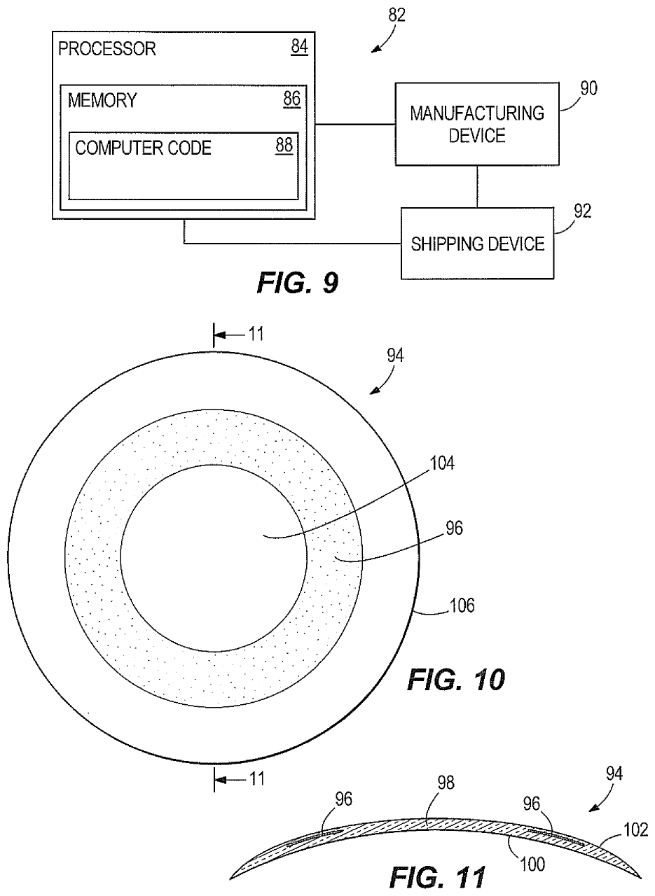

FIG. 9 illustrates a box diagram of one embodiment of a system 82 which may be used to manufacture contact lenses using the methods disclosed herein. The system 82 comprises a processor 84, a memory 86, computer code 88, at least one manufacturing device 90, and at least one shipping device 92. The processor 84 is in electronic communication with the memory 86. The computer code 88 is stored in the memory 86. The computer code 88 comprises instructions to allow the processor 84 to control the manufacturing device 90 and the at least one shipping device 92 to manufacture and ship the contact lens. The instructions may comprise any of the methods disclosed herein.

The at least one manufacturing device 90 may comprise any number and type of manufacturing device such as a mold, a lathe, a casting device, a pad printing device, or another type of manufacturing device. The at least one manufacturing device 90 and/or the at least one shipping device 92 may include a robot to move the manufactured contact lens from the at least one manufacturing device 90 to the at least one shipping device 92. The contact lens is formed using the at least one manufacturing device 90, and then packaged and shipped using the at least one shipping device 92. In other embodiments, the system 82 may include varying additional devices to assist in manufacturing and shipping the contact lens.

FIG. 10 illustrates a top view of one embodiment of a contact lens 94 formed using the system and/or methods disclosed herein. FIG. 11 illustrates a cross-section view through line 11-11 of the contact lens 94 of FIG. 10. As collectively shown in FIGS. 10-11, the contact lens 94 comprises a layer 96 of bioactive agents disposed in an interior 98 of the contact lens 94 between exterior layers 100 and 102 of the contact lens 94. The layer 96 of bioactive agents is disposed outside of a center portion 104, comprising an intended line of vision, of the contacts lens 94 to avoid interfering with vision when worn over an eye. The layer 96 of bioactive agents is circular and is disposed around the center portion 104 in between the center portion 104 and a circular external perimeter 106 of the contact lens. In other embodiments, the bioactive agents may be disposed in varying locations, configurations, shapes, volumes, and sizes in or on the contact lens.

The Abstract is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

While particular aspects of the present subject matter described herein have been shown and described, it will be apparent to those skilled in the art that, based upon the teachings herein, changes and modifications may be made without departing from the subject matter described herein and its broader aspects and, therefore, the appended claims are to encompass within their scope all such changes and modifications as are within the true scope of the subject matter described herein. Furthermore, it is to be understood that the disclosure is defined by the appended claims. Accordingly, the disclosure is not to be restricted except in light of the appended claims and their equivalents.

1. A method of forming and/or using a contact lens comprising:
pad printing bioactive agents to form a layer; and
curing the layer to form a portion of the contact lens.

2. The method of claim 1 wherein the pad printing the bioactive agents to form the layer comprises pad printing the bioactive agents on a pre-manufactured contact lens, and the curing the layer to form the portion of the contact lens comprises curing the layer on the pre-manufactured contact lens to form the portion of the contact lens.

3. The method of claim 1 wherein the pad printing the bioactive agents to form the layer comprises pad printing the bioactive agents to form the layer during manufacture of the contact lens.

4. The method of claim 1 further comprising, after the pad printing and curing, shipping the contact lens in a dry state.

5. The method of claim 1 further comprising forming the contact lens so that the layer of the pad printed bioactive agents is disposed within an interior of the contact lens between exterior layers.

6. The method of claim 1 wherein the pad printing the bioactive agents to form the layer comprises pad printing the bioactive agents outside of a center portion, comprising an intended line of vision, of the contact lens.

7. The method of claim 1 further comprising pad printing the layer directly onto a second layer.

8. The method of claim 7 further comprising pad printing the layer directly onto the second layer which is disposed on a portion of a mold.

9. The method of claim 8 further comprising pad printing the second layer on the portion of the mold.

10. The method of claim 8 further comprising filling the portion of the mold with a monomer mix.

11. The method of claim 9 further comprising surface treating the portion of the mold, and then disposing the second layer directly onto the surface treated portion of the mold.

12. The method of claim 11 further comprising injection molding the mold.

13. The method of claim 1 further comprising pad printing the layer directly onto a portion of a mold.

14. The method of claim 13 further comprising filling the portion of the mold with a monomer mix.

15. The method of claim 1 further comprising:
pad printing a second layer directly onto a mold;
curing the second layer;
pad printing the layer of the bioactive agents directly onto the second layer;
curing the layer;
filling the mold with a monomer mix;
closing the mold;
curing the monomer mix;
opening the mold; and
removing the contact lens, formed by the cured layer, the cured second layer, and the cured monomer mix, from the mold.

16. The method of claim 15 further comprising surface treating a portion of the mold, pad printing the second layer directly onto the surface treated portion of the mold, and filling the mold with the monomer mix.

17. The method of claim 15 further comprising shipping the contact lens in a dry state.

18. The method of claim 15 further comprising forming the contact lens so that the layer of the bioactive agents is disposed within an interior of the contact lens between exterior layers of the contact lens.

19. The method of claim 15 wherein the pad printing the layer of the bioactive agents directly onto the second layer comprises pad printing the layer of the bioactive agents outside of a center portion, comprising an optical zone, of the contact lens.

20. The method of claim 15 further comprising injection molding the mold.

21. The method of claim 1 further comprising, after the pad printing and curing:
disposing the contact lens in a first shape in a liquid buffer solution for less than five minutes; and
then the contact lens changing into a second intended shape without distortion after being in the liquid buffer solution for less than five minutes.

22. The method of claim 21 further comprising, after the pad printing and curing, shipping the contact lens in a dry state, and then disposing the dry state contact lens in the first shape in the liquid buffer solution for less than the five minutes.

23. The method of claim 22 further comprising removing the contact lens, in the second intended shape without distortion, from the liquid buffer solution after being in the liquid buffer solution for less than the five minutes, and then disposing the contact lens, in the second intended shape without distortion in an eye.

24. A method of forming and/or using a contact lens comprising:
soaking a pre-manufactured contact lens in a solution of bioactive agents so that the pre-manufactured contact lens uploads the bioactive agents into the pre-manufactured contact lens to form the contact lens;
then drying the contact lens and shipping the contact lens in a dry state;
then disposing the contact lens in a first shape in a liquid buffer solution for less than five minutes; and
then the contact lens changing into a second intended shape without distortion after being in the liquid buffer solution for less than five minutes.

25. A method of forming and/or using a contact lens comprising:
filling a mold with a monomer mix comprising bioactive agents;
closing the mold;
curing the monomer mix;
opening the mold; and
removing the contact lens, formed by the cured monomer mix, from the mold.

26. The method of claim 25 further comprising shipping the contact lens in a dry state, then disposing the contact lens in a first shape in a liquid buffer solution for less than five minutes, and then the contact lens changing into a second intended shape without distortion after being in the liquid buffer solution for less than five minutes.
